(19) United States
(12) Patent Application Publication
(10) Pub. No.: US 2021/0211015 A1
(43) Pub. Date: Jul. 8, 2021

(54) Boot structure of silicon steel sheet

(71) Applicant: LEE MING CHANG, Taipei City 111 (TW)

(72) Inventor: LEE MING CHANG, Taipei City 111 (TW)

(21) Appl. No.: 16/733,321

(22) Filed: Jan. 3, 2020

(51) Int. Cl. H02K 5/24

(52) U.S. Cl. CPC H02K 5/24

(57) ABSTRACT

A boot structure of a silicon steel sheet contains: a peripheral extension and multiple boot portions. The multiple boot portions are connected with the peripheral extension and surround an inner wall of the peripheral extension. A first concaved face is formed on a first portion of the boot portion, a second concaved face is formed on a second portion of the boot portion, and an intersection point is formed on a connection portion of the first concaved face and the second concaved face.

### FIELD OF THE INVENTION

The present invention relates to a single phase brushless motor, and more particularly to a boot structure of a silicon steel sheet.

### BACKGROUND OF THE INVENTION

A conventional single phase brushless motor contains a stator and a rotator rotating relative to the stator.

The stator includes a wind winding set, when an electric current (such as 110V of alternating current) flows into a coil of the wind winding set, a magnetic field produces. According to Lenz's Law, a new electric current generates, the rotor rotates to generate new electric currents and a new magnetic field to the stator. According to Fleming's left-hand rule, when the electric field and magnetic field interact, the motor has the force (or torque) for driving the rotor to rotate relative to the stator.

However, a dead point makes the torque of a single-phase motor equal to zero. Therefore, the motor receives a load which may stop the rotor at a dead point, thus causing the motor to stand still and fail to turn on.

Some motors use the Hall effect. The Hall sensor measures the strength and direction of the magnetic field, changes the direction of the current in the winding group, and changes the voltage difference to maintain the rotation of the rotor.

The present invention has arisen to mitigate and/or obviate the afore-described disadvantages.

### SUMMARY OF THE INVENTION

The primary aspect of the present invention is to provide a boot structure of a silicon steel sheet which avoids a stop, vibration, and noises of a motor.

To obtain above-mentioned aspect a boot structure of a silicon steel sheet provided by the present invention contains: a peripheral extension and multiple boot portions.

The multiple boot portions are connected with the peripheral extension and surrounding an inner wall of the peripheral extension.

A first concaved face is formed on a first portion of the boot portion, a second concaved face is formed on a second portion of the boot portion, and an intersection point is formed on a connection portion of the first concaved face and the second concaved face.

The first concaved face is formed on the first portion of the boot portion along a first dotted curve line, and the second concaved face is formed on the second portion of the boot portion along a second dotted curve line, wherein the first dotted curve line and the second dotted curve line are not concentric.

### BRIEF DESCRIPTION OF THE DRAWINGS

FIG. 1 is a side plan view showing the assembly of a silicon steel sheet according to a preferred embodiment of the present invention.

FIG. 2 is a cross sectional view showing the assembly of a part of the silicon steel sheet according to the preferred embodiment of the present invention.

### DETAILED DESCRIPTION OF THE PREFERRED EMBODIMENTS

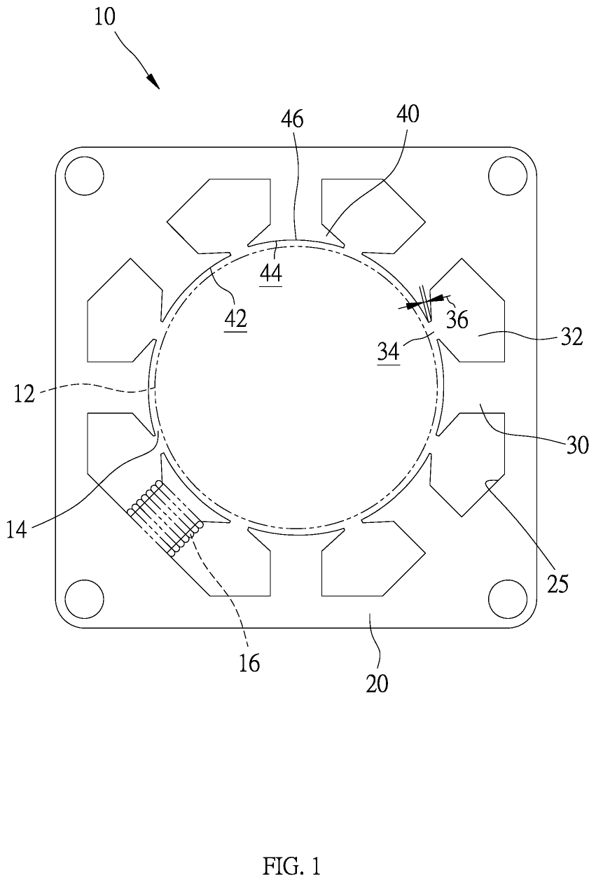

With reference to FIG. 1, a silicon steel sheet 10 according to a preferred embodiment of the present invention comprises: a peripheral extension 20 surrounding a rotor 12, wherein the peripheral extension 20 includes multiple toothed portions 30 and multiple boot portions 40 corresponding to the multiple toothed portions 30 respectively.

The multiple toothed portions 30 radially extend to the rotor 12 from an internal rim 25 of the peripheral extension 20, the multiple boot portions 40 are supported by the multiple toothed portions 30 and are formed around the rotor 12, and an air gap 14 is defined among the multiple boot portions 40 and the rotor 12.

The silicon steel sheet 10 further comprises multiple recesses 32, wherein a respective one recess 32 is defined by any two adjacent toothed portions 30 and the peripheral extension 20 and communicates with the air gap 14 via an opening 34 between any two adjacent boot portions 40. A single conductive wire is inserted into the respective one recess 32 via the opening 34 and surrounds a respective one toothed portion 30 so as to produce a wire winding set 16. When the wire winding set 16 produces a magnetic field and reacts with an electric field, it drives the rotor 12 to rotate relative to the silicon steel sheet 10 (i.e., the stator), such that the stator matches with the rotor 12 so form a single phase brushless motor.

A respective one boot portion 40 includes a first concaved face 42 and a second concaved face 44 formed on two sides of a bottom of the respective one boot portion 40 which face the air gap 12, and an intersection point 46 formed on a connection portion of the first concaved face 42 and the second concaved face 44, wherein a width of a first portion of the respective one boot portion 40 defined among a first outer side of the respective one boot portion 40, the first concaved face 42, and the intersection point 46 is different from a width of a second portion of the respective one boot portion 40 defined among a second outer side of the respective one boot portion 40, the second concaved face 44, and the intersection point 46 so as to influence a depth 36 of the opening 34 and to form the air gap 14 which is uneven, thus changing a magnetic flux density of the silicon steel sheet 10 (i.e., the stator) and a magnetic energy. When the magnetic field increases, it attracts the rotor 12 strongly to avoid a stop, vibration, and noises of a motor.

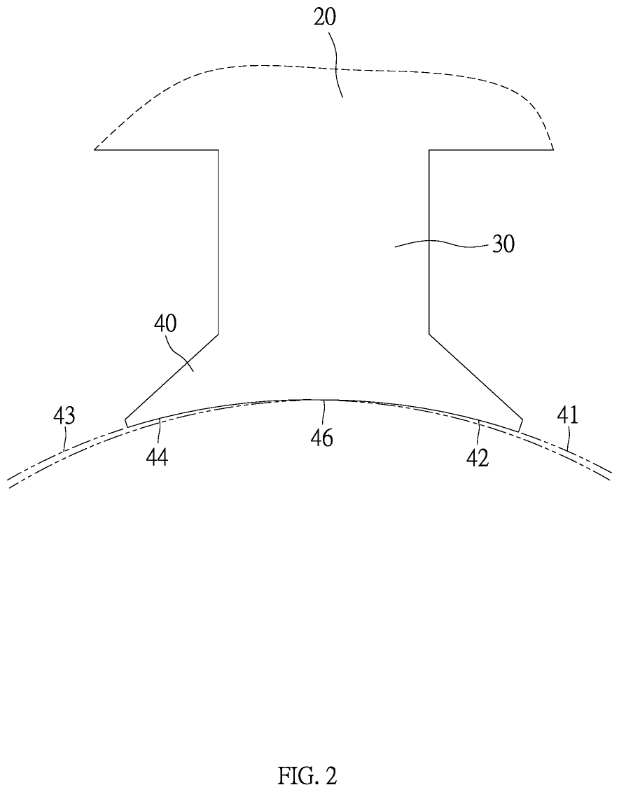

As illustrated in FIG. 2, the first concaved face 42 is formed on the first portion of the boot portion 40 along a first dotted curve line 41, and the second concaved face 44 is formed on the second portion of the boot portion 40 along a second dotted curve line 43, wherein the first dotted curve line 41 and the second dotted curve line 43 are not concentric.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A boot structure of a silicon steel sheet comprising:
a peripheral extension;
multiple boot portions connected with the peripheral extension and surrounding an inner wall of the peripheral extension;
wherein a first concaved face is formed on a first portion of the boot portion, a second concaved face is formed on a second portion of the boot portion, and an intersection point is formed on a connection portion of the first concaved face and the second concaved face.

2. The boot structure of a silicon steel sheet as claimed in claim 1, wherein the first concaved face is formed on the first portion of the boot portion along a first dotted curve line, and the second concaved face is formed on the second portion of the boot portion along a second dotted curve line, wherein the first dotted curve line and the second dotted curve line are not concentric.
